(19) United States
(12) Patent Application Publication
(10) Pub. No.: US 2024/0154529 A1
(43) Pub. Date: May 9, 2024

(54) Boost Converter Having Inactive Load Mode with Low Output Voltage Ripple

(71) Applicant: TEXAS INSTRUMENTS INCORPORATED, Dallas, TX (US)

(72) Inventors: Chen FENG, Shanghai (CN); Jian LIANG, Shanghai (CN); Guangxu WANG, Shanghai (CN)

(21) Appl. No.: 18/152,416

(22) Filed: Jan. 10, 2023

Related U.S. Application Data
(60) Provisional application No. 63/382,790, filed on Nov. 8, 2022.

(51) Int. Cl. H02M 3/158; H02M 1/00

(52) U.S. Cl. CPC H02M 3/158; H02M 1/0009; H02M 1/0032

(57) ABSTRACT

A boost converter control method includes: receiving an output voltage; receiving an output voltage target; triggering a snooze phase start of an inactive load mode based on a comparison of the output voltage relative to the output voltage target plus a first output voltage target offset; and triggering a snooze phase end of the inactive load mode based on a comparison of the output voltage relative to the output voltage target plus a second output voltage target offset, the second output voltage target offset greater than the first output voltage target offset.

### CROSS-REFERENCE TO RELATED APPLICATIONS

This application claims priority to U.S. Provisional Application No. 63/382,790, filed Nov. 8, 2022, which is hereby incorporated by reference.

### BACKGROUND

Many applications (e.g., low-power wireless systems, analog front-end (AFE) systems, radio frequency (RF) systems, portable products, etc.) need direct-current-to-direct-current (DC-DC) converters with high efficiency and low output voltage (V_{OUT}) ripple when there is a low load condition. The DC-DC converter has a power stage that usually includes a low-side switch coupled between a switching terminal and ground, and a high-side switch coupled between the switching terminal and an output terminal. The DC-DC converter also includes a controller configured to support different operational modes such as a pulse-width modulation (PWM) mode, a pulse-frequency modulation (PFM) mode, and an ultra-low quiescent current (ULIQ) mode depending on the load condition.

In the PWM mode, the low-side switch and the high-side switch are configured to switch alternately during a switching cycle. Each switching cycle includes high-side switch on period and a low-side switch on period. There may be a gap between the high-side switch on period and the low-side switch on period, but there is no overlap.

In the PFM mode, each switching cycle further includes an off period after the low-side switch on period and the-side switch on period to improve switching efficiency when the load is light. The maximum switching cycle in the PFM mode is controlled based on a PFM timer circuit, which generates a control signal (PFM_END) to end the off period and start a switching cycle.

For the PWM and PFM modes, switching of the low-side switch and the high-side switch is controlled by: comparing V_{OUT} with a reference voltage (V_{REF}) using an error amplifier; sensing inductor current (I_{L}) flowing through an inductor coupled between the switching terminal and an input terminal of the power stage; and comparing the sensed I_{L} with the output from the error amplifier.

The ULIQ mode is used to improve the efficiency of the power stage when the load current is even smaller (e.g., when load current is below a threshold such as 10 mA). The ULIQ mode includes a SWITCH phase and a SNOOZE phase. In the SNOOZE phase, sensing I_{L} can be disabled, and switching of the low-side switch and the high-side switch is controlled by a low power comparator or a dynamic comparator with a low sampling clock based on V_{OUT} and a ULIQ reference voltage.

V_{OUT} accuracy is a critical parameter in a DC-DC converter. Whether operating in the PWM mode, the PFM mode, or the ULIQ mode, the difference between V_{OUT} and a target V_{OUT} should be as small as possible. Efficiency issues during transitions between the PFM mode and ULIQ mode, and V_{OUT} ripple issues during the ULIQ mode are known issues in a conventional approach.

### SUMMARY

In an example embodiment, a boost converter control method comprises: receiving an output voltage; receiving an output voltage target; triggering a snooze phase start of an inactive load mode based on a comparison of the output voltage relative to the output voltage target plus a first output voltage target offset; and triggering a snooze phase end of the inactive load mode based on a comparison of the output voltage relative to the output voltage target plus a second output voltage target offset, the second output voltage target offset greater than the first output voltage target offset.

In another example embodiment, a controller comprises boost control circuitry having a first control input, a second control input, a third control input, a fourth control input, a first control output, a second control output, a third control output, a fourth control output, and a fifth control output. The controller also comprises pulse-width modulation/pulse-frequency modulation (PWM/PFM) mode control circuitry having a fifth control input, a sixth control input, a seventh control input, an eighth control input, a ninth control input, a tenth control input, a sixth control output, a seventh control output, an eighth control output, a ninth control output and a ground terminal, the ninth control input coupled to the second control output, the tenth control input coupled to the third control output, the seventh control output coupled to the first control input, eighth control output coupled to the second control input, the ninth control output coupled to the third control input. The controller also comprises inactive load mode control circuitry having an eleventh control input, a twelfth control input, a thirteenth control input, a fourteenth control input, a clock input, and a tenth control output, the fourteenth control input coupled to first control output, the tenth control output coupled to the fourth control input. The inactive load mode control circuitry configured to: use a first output voltage target offset to trigger a snooze phase start of an inactive load mode; and use a second output voltage target offset to trigger a snooze phase end of the inactive load mode, the second output voltage target offset greater than the first output voltage target offset.

In yet another example embodiment, a system comprises a power stage having a first power input, a first ground terminal, first and second control inputs, and a power output. The system also comprises a controller having a first and second sense inputs, a second ground terminal and first and second control outputs, the sense input coupled to the power output, the first control output coupled to the first control input, the second control output coupled to the second control input. The controller including boost control circuitry, PWM/PFM mode control circuitry and inactive load mode control circuitry. The inactive load mode control circuitry is configured to: use a first output voltage target offset to trigger a snooze phase start of an inactive load mode; and use a second output voltage target offset to trigger a snooze phase end of the inactive load mode, the second output voltage target offset greater than the first output voltage target offset.

### BRIEF DESCRIPTION OF THE DRAWINGS

FIG. 1 is a block diagram showing a system in accordance with an example embodiment.

FIG. 2 is a diagram showing a system in accordance with an example embodiment.

FIG. 3 is a graph showing mode transition efficiency as a function of load current in accordance with an example embodiment.

FIG. 4 is a graph showing signals related to an inactive load mode in accordance with a conventional approach.

FIG. 5 is a schematic diagram showing pulse-width modulation and pulse-frequency modulation (PWM/PFM) mode control circuitry of the controller of FIG. 2 in accordance with an example embodiment.

FIG. 6 is a schematic diagram showing a PFM timer circuit of the PWM/PFM mode control circuitry of FIG. 5 in accordance with an example embodiment.

FIG. 7 is a timing diagram showing signals related to the PFM timer circuit of FIG. 6 in accordance with an example embodiment.

FIG. 8 is a schematic diagram showing a snooze current (I_{SNOOZE}) source of the PWM/PFM mode control circuitry of FIG. 5 in accordance with an example embodiment.

FIG. 9 is a schematic diagram showing inactive load mode control circuitry of the controller of FIG. 2 in accordance with an example embodiment.

FIG. 10 is a schematic diagram showing boost control circuitry of the controller of FIG. 2 in accordance with an example embodiment.

FIG. 11 is a timing diagram showing signals related to different operational modes of a controller in accordance with an example embodiment.

FIG. 12 is a timing diagram showing inductor current (I_{L}) during a PWM mode of a controller in accordance with an example embodiment.

FIG. 13 is a timing diagram showing I_{L} during a PFM mode of a controller in accordance with an example embodiment.

FIG. 14 is a timing diagram showing I_{L} and a power stage output voltage (V_{OUT}) during a mode transition of a controller in accordance with an example embodiment.

FIG. 15 is a timing diagram showing signals related to an inactive load mode of a controller in accordance with an example embodiment.

### DETAILED DESCRIPTION

The same reference numbers or other reference designators are used in the drawings to designate the same or similar (either by function and/or structure) features.

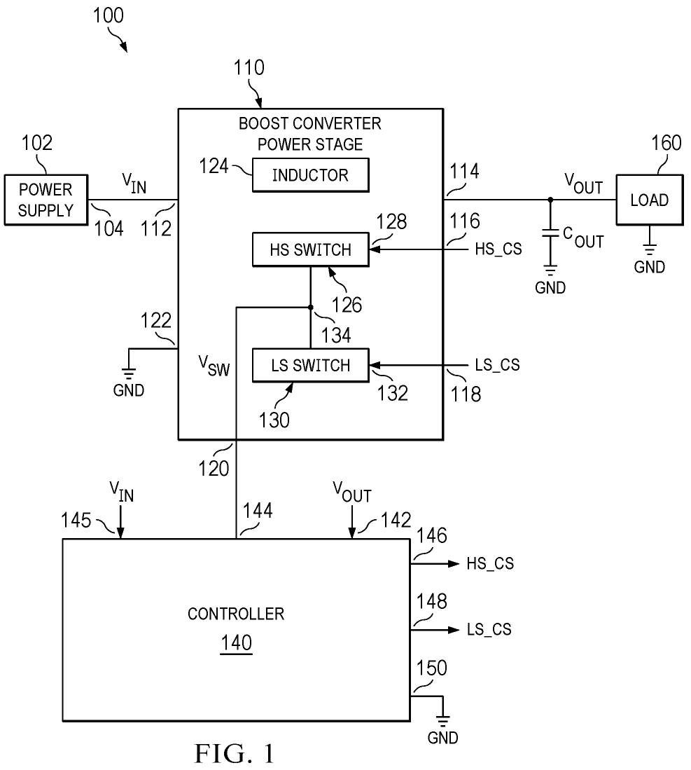

FIG. 1 is a block diagram showing a system 100 in accordance with an example embodiment. As shown, the system 100 includes a power supply 102, a boost converter power stage 110, a controller 140 for the boost converter power stage 110, a load 160, and an output capacitor (C_{OUT}) in the arrangement shown. In some example embodiments, the system 100 may include additional components such as in input capacitor (C_{IN}) between the power supply 102 and the boost converter power stage 110.

In the example of FIG. 1, the power supply 102 has a power supply output 104. The boost converter power stage 110 has a power input 112, a power output 114, a first control input 116, a second control input 118, a sense output 120 and a ground terminal 122. The boost converter power stage 110 includes an inductor 124, a high-side (HS) switch 126 and a low-side (LS) switch 130. In the example of FIG. 1, the HS switch 126 includes a control terminal 128 coupled to the first control input 116, and the LS switch 130 includes a control terminal 132 coupled to the second control input 118. Between the HS switch 126 and the LS switch 130 is a switch node 134 coupled to the sense output 120. During operations of the boost converter power stage 110, the sense output 120 provides a switch node voltage (V_{SW}).

In different example embodiments, the topology (e.g., the arrangement of the inductor 124, the HS switch 126, and the LS switch 130) of the boost converter power stage 110 may vary. Regardless of topology, the boost converter power stage 110 is configured to regulate power to the load 160 based on the input voltage (V_{IN}) provided by the power supply 102, a target output voltage (V_{OUT_TAR}) for an output voltage (V_{OUT}), and the operations of the controller 140. In order to improve efficiency of the boost converter power stage 110, the controller 140 is configured to support different operational modes. Example operational modes supported by the controller 140 include a pulse-width modulation (PWM) mode, a pulse-frequency modulation (PFM) mode, and an inactive load mode. The inactive load mode is sometimes referred to herein as an ultra-low quiescent current (ULIQ) mode.

For the different operational modes, the current in the inductor 124 may be limited. In light load scenarios, the inactive load mode is preferred over a PWM mode or a PFM mode to reduce power consumption. However, V_{OUT} ripple can increase in the inactive load mode. To reduce V_{OUT} ripple in an inactive load mode, the controller 140 monitors V_{OUT} relative to V_{OUT_TAR} and two output voltage target offsets (V_{OFFSET1} and V_{OFFSET2}). V_{OUT_TAR}+V_{OFFSET1} is used to determine when a snooze phase of the inactive load mode starts. V_{OUT_TAR}+V_{OFFSET2} is used to determine when the snooze phase of the inactive load mode ends. Relative to a conventional approach, the controller 140 reduces V_{OUT} ripple in the inactive load mode by using negative hysteresis control and a V_{OFFSET2} value that is greater than the V_{OFFSET1} value. As an example and without limitation, if a V_{OUT_TAR} of 5V is assumed, then V_{OFFSET2} may be 50 mV and V_{OFFSET1} may be 25 mV. In such case, negative hysteresis control and a V_{OFFSET2} value greater than the V_{OFFSET1} value, can reduce V_{OUT} ripple during the inactive load mode from about 25 mV to about 5 mV.

The controller 140 is also configured to support smooth transitions between the inactive load mode and other modes (e.g., a PFM mode or a PWM mode). For each of the operational modes and transitions, the HS switch 126 is controlled by a high-side control signal (HS_CS) provided by the controller 140, while the LS switch 130 is controlled by a low-side control signal (LS_CS) provided by the controller 140.

In some example embodiments, the controller 140 has a first sense input 142, a second sense input 144, a third sense input 145, a first control output 146, a second control output 148, and a ground terminal 150. The first sense input 142 is coupled to the power output 114 of the boost converter power stage 110 and receives V_{OUT}. The second sense input 144 is coupled to the sense output 120 of the boost converter power stage 110 and receives V_{SW}. The third sense input 145 is coupled to the power supply output 104 and is received V_{IN}. The first control output 146 provides HS_CS responsive to operations of the controller 140 and is coupled to the first control input 116 of the boost converter power stage 110. The second control output 148 provides LS_CS responsive to operations of the controller 140 and is coupled to the second control input 118 of the boost converter power stage 110.

In operation, the controller 140 is configured to adjust parameters (e.g., the on-time, the off-time, a turn on trigger, a turn off trigger, the frequency, etc.) of HS_CS at the first controller output 146 and of LS_CS at the second controller output 148 based on various control options and related circuits. In some example embodiments, the controller 140 includes boost control circuitry, PWM/PFM mode control circuitry, and inactive load mode control circuitry. In operation, the boost control circuitry is configured to adjust HS_CS and LS_CS responsive to control signals such as a switching on signal (SWITCH), a peak inductor current signal (PEAK_HI), an inductor current valley detect signal (CLIM_VALLEY), and an end PFM mode signal (PFM_END). The boost control circuitry may also be configured to provide a pause signal (PAUSE) to the inactive load mode control circuitry responsive to PFM_END, a low-side on signal (LS_ON) and CLIM_VALLEY. The PWM/PFM mode control circuitry is configured to: provide PFM_END signal to the boost control circuitry responsive to an error amplifier current (I_{EA}); provide a light load signal (LIGHT_LOAD) to the inactive load mode control circuitry responsive to V_{IN}, V_{OUT} and V_{OUT_TAR}; provide CLIM_VALLEY to the boost control circuitry responsive to V_{OUT} and a high-side voltage sense signal (V_{HS_SNS}); and provide PEAK_HI to the boost control circuitry responsive to V_{SW} and a low-side voltage sense signal (V_{LS_SNS}). The inactive load mode control circuitry is configured to: use negative voltage control for snooze start and snooze end control; and provide SWITCH to the boost control circuitry responsive to V_{OUT}, V_{OUT_TAR}, V_{OFFSET1}, and V_{OFFSET2}. Without limitation, the circuits and related operations of the controller 140 enable reduced V_{OUT} ripple and smoother operating mode transitions compared to a conventional approach.

In some example embodiments, the controller 140 is configured to adjust HS_CS LS_CS based on inactive load mode operations that include snooze control operations (e.g., snooze start control operations and snooze end control operations). Example snooze start control operations compare V_{OUT} with V_{OUT_TAR}+V_{OFFSET1}. If V_{OUT} exceeds V_{OUT_TAR}+V_{OFFSET1}, a snooze phase start is triggered (possibly subject to other constraints such as LIGHT_LOAD and/or PAUSE). Example snooze end control operations compare V_{OUT} with V_{OUT_TAR}+V_{OFFSET2}. If V_{OUT} exceeds V_{OUT_TAR}+V_{OFFSET2}, a snooze phase end is triggered. Again, the controller 140 may use negative hysteresis control and V_{OFFSET2} greater than V_{OFFSET1} for snooze control operations. Besides controlling HS_CS and LS_CS based on inactive load mode operations as needed, the controller 140 is configured to control HS_CS and LS_CS based on other modes of operations (e.g., the PFM mode, the PWM mode, or transition modes).

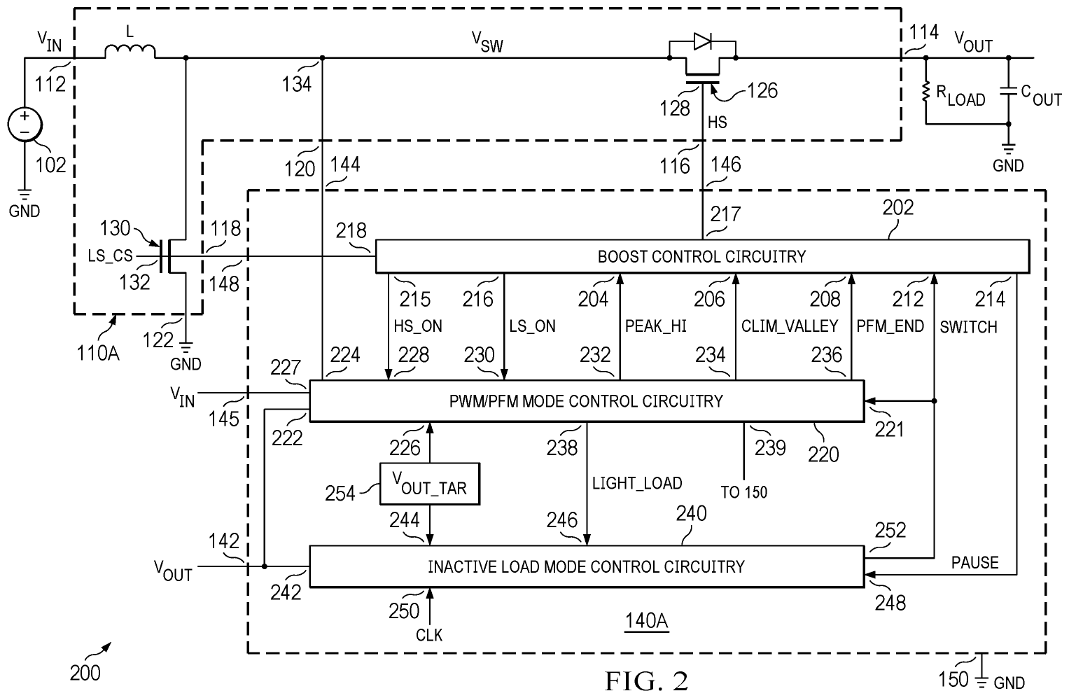

FIG. 2 is a diagram showing a system 200 in accordance with an example embodiment. In the example of FIG. 2, the system 200 includes a boost converter power stage 110A (an example of the boost converter power stage 110 in FIG. 1) coupled between a power supply 102A (an example of the power supply 102 in FIG. 1) and a load (R_{LOAD}), where R_{LOAD} is an example of the load 160 in FIG. 1. As shown, R_{LOAD} is in parallel with C_{OUT} between the power output 114 of the boost converter power stage 110A and a ground terminal (GND).

In the system 200, the boost converter power stage 110A regulates power to R_{LOAD} based on V_{IN} from the power supply 102. In operation, the boost converter power stage 110A is configured to: receive V_{IN} at the power input 112; receive HS_CS at the first control input 116; receive LS_CS at the second control input 118; and regulate V_{OUT} at the power output 114 responsive to HS_CS and LS_CS. In the example of FIG. 2, the boost converter power stage 110 is also configured to provide V_{SW} to the sense output 120.

In the example of FIG. 2, HS_CS and LS_CS are provided by the controller 140A (an example of the controller 140 in FIG. 1) based on the operations of various circuits, including: boost control circuitry 202; PWM/PFM mode control circuitry 220; and inactive load mode control circuitry 240. As shown, the controller 140A has the first sense input 142, the second sense input 144, the third sense input 145, the first control output 146, the second control output 148, and the ground terminal 150 described for the controller 140 of FIG. 1. The boost control circuitry 202 has a first control input 204, a second control input 206, a third control input 208, a fourth control input 212, a first control output 214, a second control output 215, a third control output 216, a fourth control output 217, and a fifth control output 218. The PWM/PFM mode control circuitry 220 has a first control input 221, a second control input 222, a third control input 224, a fourth control input 226, a fifth control input 227, a sixth control input 228, a seventh control input 230, a first control output 232, a second control output 234, a third control output 236, a fourth control output 238, and a ground terminal 239. The inactive load mode control circuitry 240 has a first control input 242, a second control input 244, a third control input 246, a fourth control input 248, a clock input 250, and a control output 252.

In the example of FIG. 2, the first control input 204 of the boost control circuitry 202 is coupled to the first control output 232 of the PWM/PFM mode control circuitry 220 and receives PEAK_HI. The second control input 206 of the boost control circuitry 202 is coupled to the second control output 234 of the PWM/PFM mode control circuitry 220 and receives CLIM_VALLEY. The third control input 208 of the boost control circuitry 202 is coupled to third control output 236 of the PWM/PFM mode control circuitry 220 and receives PFM_END. The fourth control input 212 is coupled to the control output 252 of the inactive load mode control circuitry 240 and receives SWITCH. The first control output 214 of the boost control circuitry 202 is coupled to the fourth control input 248 of the inactive load mode control circuitry 240 and provides PAUSE. The second control output 215 of the boost control circuitry 202 is coupled to the sixth control input 228 of the PWM/PFM mode control circuitry 220 and provides a high-side on signal (HS_ON). The third control output 216 of the boost control circuitry 202 is coupled to the seventh control input 230 of the PWM/PFM mode control circuitry 220 and provides a low-side on signal (LS_ON). The fourth control output 217 is coupled to the first control output 146 of the controller 140A and provides HS_CS. The fifth control output 218 is coupled to the second control output 148 of the controller 140A and provides LS_CS.

The first control input 221 of the PWM/PFM mode control circuitry 220 is coupled to the control output of the inactive load mode control circuitry 240 and receives SWITCH. The second control input 222 of the PWM/PFM mode control circuitry 220 is coupled to the first sense input 142 of the controller 140A and receives V_{OUT}. The third control input 224 of the PWM/PFM mode control circuitry 220 is coupled to the second sense input 144 of the controller 140A and receives V_{SW}. The fourth control input 226 of the PWM/PFM mode control circuitry 220 is coupled to a V_{OUT_TAR} source 254 and receives V_{OUT_TAR}. The fifth control input 227 of the PWM/PFM mode control circuitry 220 is coupled the third sense input 145 to receive V_{IN}. The fourth control output 238 of the PWM/PFM mode control circuitry 220 is coupled to the third control input 246 of the inactive load mode control circuitry 240 and provides LIGHT_LOAD. The ground terminal 239 of the PWM/PFM mode control circuitry 220 is coupled to the ground terminal of the controller 140A.

The first control input 242 of the inactive load mode control circuitry 240 is coupled to the first sense input 142 of the controller 140A and receives V_{OUT}. The second control input 244 of the inactive load mode control circuitry 240 is coupled to the V_{OUT_TAR} source 254 and receives V_{OUT_TAR}. The clock input 250 is coupled to a sampling clock source (not shown) and receives a sampling clock signal (CLK).

In operation, the boost control circuitry 202 is configured to: receive PEAK_HI at the first control input 204; receive CLIM_VALLEY at the second control input 206; receive PFM_END at the third control input 208; receive SWITCH at the fourth control input 212; provide PAUSE at the first control output 214 responsive to CLIM_VALLEY, PFM_END, and LS_ON; provide HS_ON at the second control output 215 responsive to PEAK_HI, PFM_END, CLIM_VALLEY, and SWITCH; provide LS_ON at the third control output 216 responsive to PEAK_HI, PFM_END, CLIM_VALLEY, and SWITCH; provide HS_CS at the fourth control output 217 responsive to HS_ON; and provide LS_CS at the fourth control output 218 responsive to LS_ON.

In operation, the PWM/PFM mode control circuitry 220 is configured to: receive SWITCH at the first control input 221; receive V_{OUT} at the second control input 222; receive V_{SW} at the third control input 224; receive V_{OUT_TAR} at the fourth control input 226; receive V_{IN} at the fifth control input 227; receive HS_ON at the sixth control input 228; receive LS_ON at the seventh control input 230; provide PEAK_HI at the first control output 232 responsive to V_{SW} and V_{LS_SNS}; provide CLIM_VALLEY at the second control output 234 responsive to V_{OUT} and V_{HS_SNS}; provide PFM_END at the third control output 236 responsive to I_{EA}; and provide LIGHT_LOAD at the fourth control output 238 responsive to V_{IN}, V_{OUT} and V_{OUT_TAR}.

In operation, the inactive load mode control circuitry 240 is configured to: receive V_{OUT} at the first control input 242; receive V_{OUT_TAR} at the second control input 244; receive LIGHT_LOAD at the third control input 246; receive PAUSE at the fourth control input 248; receive CLK at the clock input 250; use negative hysteresis voltage control for snooze start and snooze end control; and provide SWITCH at the control output 252 responsive to V_{OUT}, V_{OUT_TAR}, LIGHT_LOAD, PAUSE, V_{OFFSET1}, and V_{OFFSET2}.

In the example of FIG. 2, the PWM mode, the PFM mode, and the inactive load mode may respectively have three different V_{OUT} levels (e.g., V_{OUT_TAR} for the PWM mode, 101%*V_{OUT_TAR} for the PFM mode, and 102%*V_{OUT_TAR} for the inactive load mode). Entering the inactive load mode from the PFM mode for different load currents will cause sharp efficiency drops or increased V_{OUT} ripple.

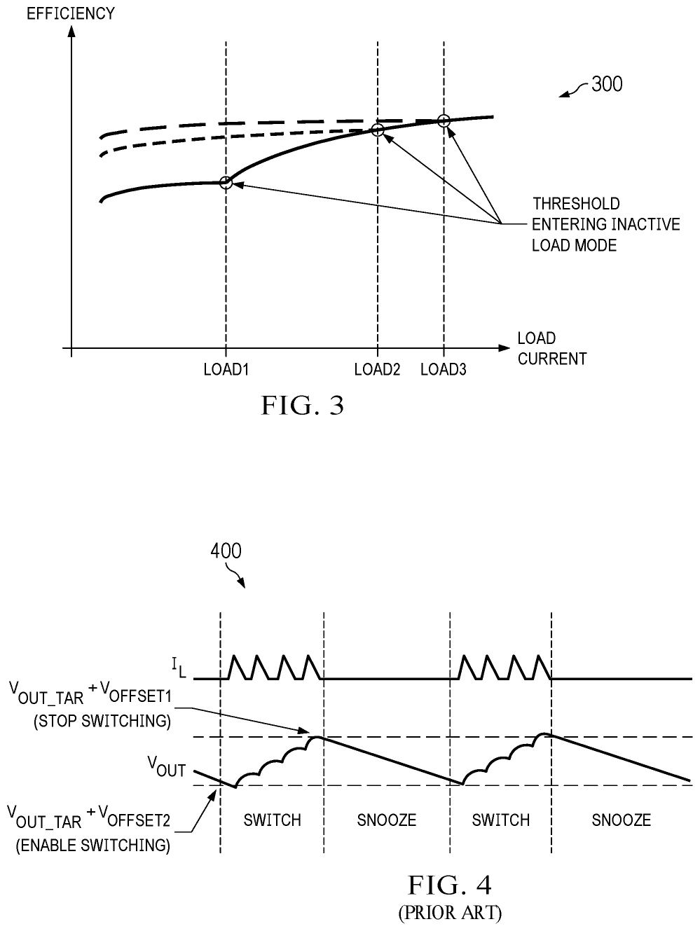

FIG. 3 is a graph 300 showing mode transition efficiency as a function of load current in accordance with an example embodiment. As shown in graph 300, the efficiency of entering the inactive load mode increases as the load current increases. Entering the inactive load mode with a small load current (load1) will cause a sharp efficiency drop. Entering the inactive load mode with heavy load (load3) will cause larger output ripple than the intended value due to the low quiescent current (I_{Q}) output comparator used to compare V_{OUT} and V_{OUT_TAR} for the inactive load mode. In some example embodiments, the load current threshold at which transitions to the inactive load mode occurs is selected to achieve target efficiency and V_{OUT} ripple. In one example embodiment, the quiescent current of the PFM mode (I_{Q_PFM}) is 100 uA. In this example, when the load current is 10 mA, efficiency only drops 1% due to I_{Q_PFM}. Without limitation, entering the inactive load mode responsive to a load current of 10 mA is sufficiently efficient for some applications.

FIG. 4 is a graph 400 showing signals related to an inactive load mode in accordance with a conventional approach. In graph 400, the signals include I_{L} and V_{OUT}. A first control threshold (V_{OUT_TAR}+V_{OFFSET1}) and a second control threshold (V_{OUT_TAR}+V_{OFFSET2}) for the inactive load mode are also shown in graph 400. V_{OUT_TAR}+V_{OFFSET1} is used to n the conventional approach of FIG. 4, V_{OUT} in the inactive load mode is between V_{OUT_TAR}+V_{OFFSET2} and V_{OUT_TAR}+V_{OFFSET2}. In the inactive load mode, V_{OUT_TAR}+V_{OFFSET2} is used to determine when the switching phase starts and the snooze phase ends, and V_{OUT_TAR}+V_{OFFSET1} is used to determine when the snooze phase starts and the switching phase ends. In the switching phase, the HS switch and the LS switch operate in alternating fashion, resulting in multiple I_{L} pulses, each causing V_{OUT} to rise. When V_{OUT} reaches V_{OUT_TAR}+V_{OFFSET1}, the switch phase ends and the snooze phase begins. In the snooze phase, the HS switch and the LS switch stop switching and V_{OUT} drops. When V_{OUT} decreases to V_{OUT_TAR}+V_{OFFSET2}, the switch phase begins again. In one conventional example, V_{OFFSET1}=50 mV and V_{OFFSET2}=25 mV, which results in V_{OUT} ripple of 25 mV for the inactive load mode. This inactive load mode V_{OUT} ripple is larger than the V_{OUT} ripple of the PWM mode or the PFM mode, and may be unacceptable for some applications.

In some example embodiments, V_{OUT} ripple and transition efficiency issues for a boost converter controller (e.g., the controller 140 of FIG. 1, or the controller 140A in FIG. 2) are managed based on: 1) use of I_{EA} to control both the valley current of I_{L} and a PFM timer circuit, achieving V_{OUT} regulation one level voltage in the PWM/PFM mode; 2) use a low-clamped I_{EA} related to V_{IN} and V_{OUT} to achieve the constant transition between PFM mode and the inactive load mode so that efficiency can be optimized for different duty cycles; 3) use the low-clamped I_{EA} to configure the PFM timer circuit to determine a maximum period of the PFM mode; and 4) use two comparators for inactive load mode V_{OUT} ripple control. By setting the thresholds of the two comparators separately and using a negative hysteresis voltage control, single pulse operation and low output ripple can be achieved.

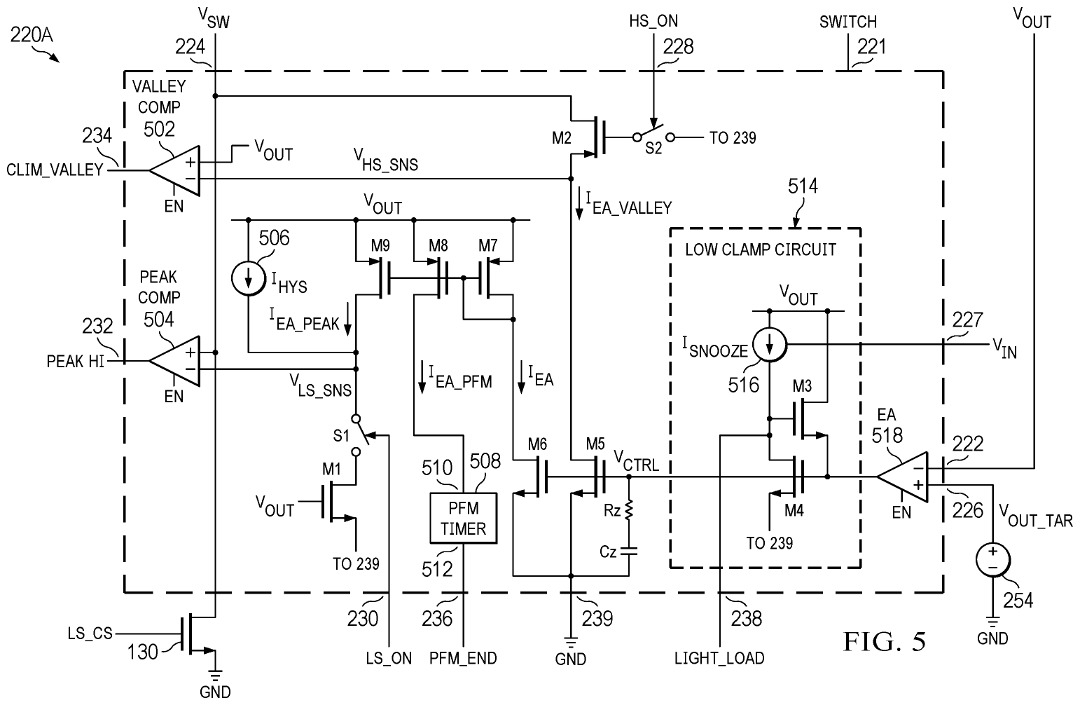

FIG. 5 is a schematic diagram showing PWM/PFM mode control circuitry 220A (an example of the PWM/PFM mode control circuitry 220 in FIG. 2) in accordance with an example embodiment. As shown, the PWM/PFM mode control circuitry 220A has the first control input 221, the second control input 222, the third control input 224, the fourth control input 226, the fifth control input 227, the sixth control input 228, the seventh control input 230, the first control output 232, the second control output 234, the third control output 236, the fourth control output 238, and the ground terminal 239.

In some example embodiments, the PWM/PFM mode control circuitry 220A includes a first comparator 502, a second comparator 504, a hysteresis current (I_{HYS}) source 506, a PFM timer circuit 508, a snooze current (I_{SNOOZE}) source 516, an error amplifier 518, transistors M1 to M8, switches S1 and S2, a resistor (Rz), and a capacitor (Cz) in the arrangement shown. As shown, the first comparator 502 has a non-inverting (“+”) input, an inverting (“−”) input, and a comparator output. The non-inverting (“+”) input of the first comparator 502 is coupled to the second control input 222. The inverting (“−”) input of the first comparator 502 is coupled to a V_{HS_SNS} node of the PWM/PFM mode control circuitry 220A. The comparator output of the first comparator 502 is coupled to the second control output 234. The second comparator 504 has a non-inverting (“+”) input, an inverting (“−”) input, and a comparator output. The non-inverting (“+”) input of the second comparator 504 is coupled to the third control input 224. The inverting (“−”) input of the second comparator 504 is coupled to a V_{LS_SNS} node of the PWM/PFM mode control circuitry 220A. The comparator output of second comparator 504 is coupled to the first control output 234. The error amplifier 518 has an inverting (“−”) input, a non-inverting (“+”) input, and an error output. The inverting (“−”) input of the error amplifier 518 is coupled to the second control input 222. The non-inverting (“+”) input of the error amplifier 518 is coupled to the fourth control input 226. The error output of the error amplifier 518 is coupled to a control voltage (VCTRL) node of the PWM/PFM mode control circuitry 220A. In the example of FIG. 5, each of the first comparator 502, the second comparator 504, and the error amplifier 518 include an enable input. In some example embodiments, the enable inputs of first comparator 502, the second comparator 504, and the error amplifier 518 are coupled to the first control input 221.

As shown, each of M1 to M9 includes a first current terminal, a second current terminal, and a control terminal. The first current terminal of M1 is coupled to the V_{HS_SNS} node via S1. The second current terminal of M1 is coupled to the ground terminal 239. The control terminal of M1 is coupled to the second control input 222. The first current terminal of M2 is coupled the third control input 224. The second current terminal of M2 is coupled to the V_{HS_SNS} node. The control terminal of M2 is coupled to a first current terminal of S2. The first current terminal of M3 is coupled to the second control input 222. The second current terminal of M3 is coupled to the VCTRL node. The control terminal of M3 is coupled to the fourth control output 238. The first current terminal of M4 is coupled to the fourth control output 238. The second current terminal of M4 is coupled to the ground terminal 239. The control terminal of M4 is coupled to the VCTRL node. The first current terminal of M5 is coupled the V_{HS_SNS} node. The second current terminal of M5 is coupled to the ground terminal 239. The control terminal of M5 is coupled to the VCTRL node. The first current terminal of M6 is coupled to the second current terminal of M7 and the control terminals of M7, M8, and M9. The second current terminal of M6 is coupled to the ground terminal 239. The control terminal of M6 is coupled to the VCTRL node. The first current terminals of M7, M8, and M9 are coupled to the second control input 222. The second current terminal of M8 is coupled to a timer input 510 of the PFM timer circuit 508. The timer output 512 of the PFM timer circuit 508 is coupled to the third control output 236. The second current terminal of M9 is coupled to the V_{LS_SNS} node.

As shown, the first current terminal of S1 is also coupled to the V_{LS_SNS} node. The second current terminal of S1 is coupled to the ground terminal 239. The control terminal of S1 is coupled to the seventh control input 230. The first current terminal of S2 is coupled to the control terminal of M2. The second current terminal of S2 is coupled to the ground terminal 239. The control terminal of S2 is coupled to the sixth control input 228. The first side of Rz is coupled to the VCTRL node. The second side of Rz is coupled to the first size of Cz. The second side of Cz is coupled to the ground terminal 239.

The first side of the I_{HYS} source 506 is coupled to the second control input 222. The second side of the I_{HYS} source 506 is coupled to the V_{LS_SNS} node. The first side of the I_{SNOOZE} source 516 is coupled to the second control input 222. The second side of the I_{SNOOZE} source 516 is coupled to the fourth control output 238. The I_{SNOOZE} source 516 is also coupled to the fifth control input 227 to receive V_{IN}. As shown, M3, M4, and the I_{SNOOZE} source 516 are part of a low clamp circuit 514 at the error output of the error amplifier 518.

In operation, the PWM/PFM mode control circuitry 220 is configured to: receive SWITCH at the first control input 221; receive V_{OUT} at the second control input 222; receive V_{SW} at the third control input 224; receive V_{OUT_TAR} at the fourth control input 226; receive HS_ON at the sixth control input 228; receive LS_ON at the seventh control input 230; provide PEAK_HI at the first control output 232 responsive to V_{SW} and V_{LS_SNS}; provide CLIM_VALLEY at the second control output 234 responsive to V_{OUT} and V_{HS_SNS}; provide PFM_END at the third control output 236 responsive to I_{EA}; and provide LIGHT_LOAD at the fourth control output 238 responsive to V_{OUT} and V_{OUT_TAR}.

In some example embodiments, a boost converter controller (e.g., the controller 140 in FIG. 1, or the controller 140A in FIG. 2) uses hysteresis current mode valley current control. In such example embodiments, the controller is configured to: sense the current flowing through LS switch 130 when turned on; sense the current flowing through the HS switch 126 when turned on; perform error amplifier operations; performs peak I_{EA} and valley I_{EA} comparator operations; perform PFM timer operations; perform PWM mode operations; performs PFM mode operations; and perform inactive load mode operations.

In some example embodiments, the controller may sense current through the HS switch 126 using a HS sense switch (e.g., M2 in FIG. 5), where the size ratio of the HS switch 126 to the HS sense switch is 10K or more. Also, the controller may sense current through the LS switch 130 using a LS sense switch (e.g., M1 in FIG. 5), where the size ratio of the LS switch 130 to the LS sense switch is 10K. The controller is also configured (e.g., using the inactive load mode) to generate signals SNOOZE and SWITCH, which are complementary to each other. When SNOOZE is asserted, various components the PWM/PFM mode control logic (e.g., the first comparator 502, the second comparator 504, and the error amplifier 518 in FIG. 5) will be disabled.

In some example embodiments, the error amplifier (e.g., the error amplifier 518 of FIG. 5) of a boost converter controller is configured to provide an error amplifier output voltage (e.g., VCTRL in FIG. 5) based on the difference between V_{OUT} and V_{OUT_TAR}. In another example embodiment, the error amplifier of a boost converter controller may be configured to provide an error amplifier output voltage (e.g., VCTRL in FIG. 5) based on a difference between a feedback voltage related to V_{OUT} and a reference voltage (V_{REF}) representative of V_{OUT_TAR}.

In the example of FIG. 5, the error amplifier output voltage (e.g., VCTRL in FIG. 5) results in I_{EA} flowing through M7, and I_{EA_VALLEY} flowing through M5. If V_{OUT} is higher than V_{HS_SNS} when HS_ON is asserted, I_{L} is lower than I_{EA_VALLEY}. In such case, CLIM_VALLEY is asserted so that I_{L} decreases to a valley value. I_{EA} is mirrored to I_{EA_PEAK} flowing through M9. If V_{LS_SNS} is lower than V_{SW} when LS_ON is asserted, I_{L} is greater than I_{EA_PEAK}+I_{HYS}. In such case, PEAK_HI is asserted so that I_{L} increases to a peak value. In one example embodiment, M5 and M6 have a size ratio of 1:1. Also, M7, M8 and M9 may have a size ratio of 1:1:1. When PEAK_HI signal is asserted, the LS switch 130 is turned off and the HS switch 126 is turned on. When CLIM_VALLEY is asserted, the LS switch 130 is turned on and the HS switch 126 is turned off. The low clamp circuit 514 is configured to low clamp the I_{EA} at I_{SNOOZE}. When I_{EA} is low clamped at I_{SNOOZE}, LIGHT_LOAD is asserted. The I_{EA} is also mirrored to I_{EA_PFM} flowing through M8 to control the PFM timer circuit 508 to determine the period in PFM mode. In one example, the period in PFM mode is inversely proportional to I_{EA_PFM}.

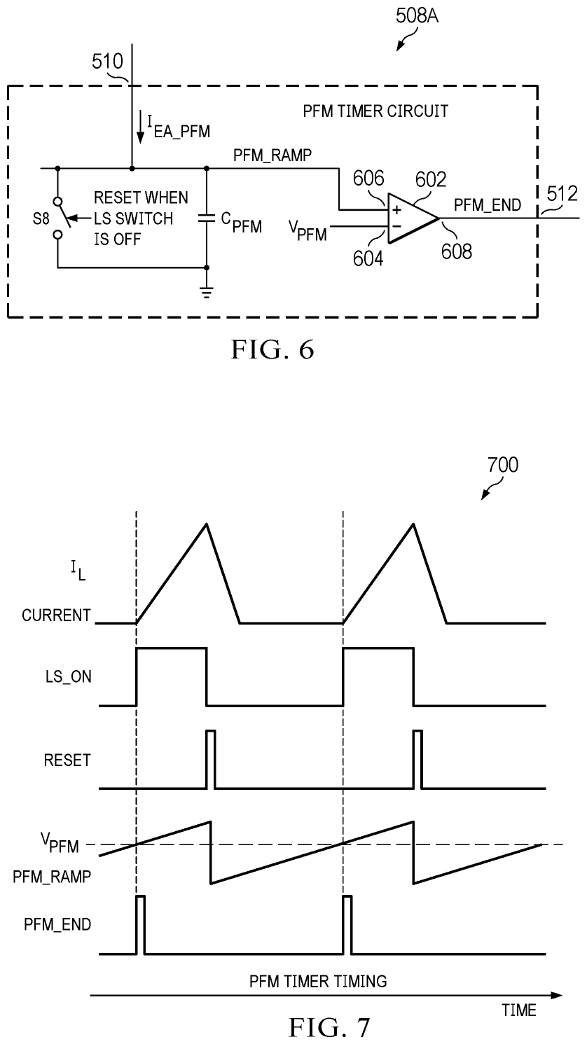

FIG. 6 is a schematic diagram showing a PFM timer circuit 508A (an example of the PFM timer circuit 508 in FIG. 5) of the PWM/PFM mode control circuitry 220 of FIG. 5 in accordance with an example embodiment. As shown, the PFM timer circuit 508A has the timer input 510 and the timer output 512. In some example embodiments, the PFM timer circuit 508A includes a comparator 602 having an inverting (“−”) input 604, a non-inverting (“+”) input 606, and a comparator output 608. The non-inverting (“+”) input 606 is coupled to the timer input 510. The inverting (“−”) input 604 is coupled to a PFM reference voltage source (not shown) and is configured to receive V_{PFM}. The comparator output 608 is coupled to the timer output 512. As shown, the PFM timer circuit 508A also includes a switch S3 and a capacitor (C_{PFM}) coupled in parallel between the timer input 510 and a ground terminal (not shown). In operation, the PFM timer circuit 508A is configured to charge C_{PFM} using I_{EA}_PFM at the timer input 510. If the charge (PFM_RAMP) on C_{PFM} exceeds V_{PFM}, the comparator 602 is configured to assert PFM_END at the comparator output 608. When the LS switch is off, S3 closes for a reset interval to clear the charge on C_{PFM} and reset the PFM timer circuit 508A. After the reset interval, S3 is opened and PFM_RAMP beings ramping up again.

FIG. 7 is a timing diagram 700 showing signals related to the PFM timer circuit 508A of FIG. 6 in accordance with an example embodiment. In the timing diagram 700, signals for I_{L}, LS_ON, RESET, and V_{PFM}, and PFM_RAMP. When the LS switch is on, LS_ON is high and the PFM timer circuit 508A will compare PFM_RAMP and V_{PFM}. When PFM_RAMP is greater than V_{PFM}, PFM_END will be asserted to indicate the end of a PFM cycle. When the LS switch is turned off, LS_ON is low and the PFM timer circuit 508A is reset for a short interval (a reset interval), which zeroes PFM_RAMP. After the reset interval, PFM_RAMP begins to ramp up again.

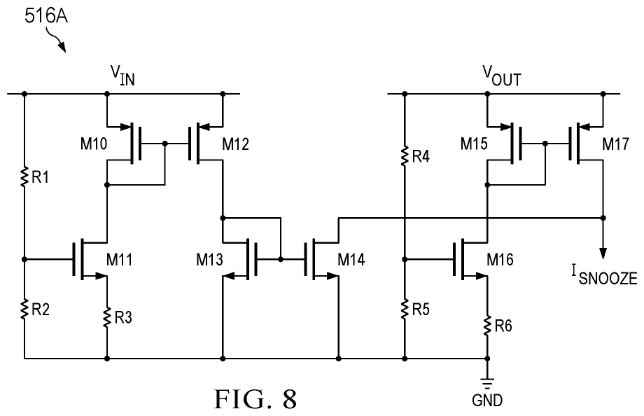

FIG. 8 is a schematic diagram showing an I_{SNOOZE} source 516A (an example of the I_{SNOOZE} source 516 in FIG. 5) of the PWM/PFM mode control circuitry of FIG. 5 in accordance with an example embodiment. In some example embodiments, the I_{SNOOZE} source 516A includes resistors R1 to R6, and transistors M10 to M17 in the arrangement shown. In the example of FIG. 8, each of M10 to M17 has a first current terminal, a second current terminal, and a control terminal. Each of R1 to R6 has a first side and a second side. In some example embodiments, M11 and M16 are native field-effect transistors (FETs) with zero threshold voltage. In some example embodiments, R1=R4, R2=R5, and R3=R6.

As shown, the first side of R1 is coupled to a V_{IN} supply (e.g., the power supply 102 in FIGS. 1 and 2). The second side of R1 is coupled to the first side of R2 and the control terminal of M11. The second side of R2 is coupled to a ground terminal. The first current terminal of M10 is coupled to the V_{IN} supply. The second current terminal of M10 is coupled to the first current terminal of M11, and the control terminals of M10 and M12. The second current terminal of M11 is coupled to the first side of R3. The second side of R3 is coupled to a ground terminal. The first current terminal of M12 is coupled to the V_{IN} supply. The second current terminal of M12 is coupled to the first current terminal of M13 and the control terminals of M13 and M14. The second current terminal of M13 is coupled to a ground terminal. The first current terminal of M14 is coupled to the second current terminal of M17. The second current terminal of M14 is coupled to a ground terminal. The first side of R4 is coupled to a V_{OUT} supply (e.g., the second control input 222 of the PWM/PFM mode control circuitry 220A in FIG. 5). The second side of R4 is coupled to the first side of R5 and the control terminal of M16. The second side of R5 is coupled to a ground terminal. The first current terminal of M15 is coupled to the V_{OUT} supply. The second current terminal of M15 is coupled to the first current terminal of M16 and the control terminals of M15 and M17. The second current terminal of M16 is coupled to the first side of R6. The second side of R6 is coupled to a ground terminal. The first current terminal of M17 is coupled to a V_{OUT} supply. The second current terminal of M17 and the first current terminal of M14 provide I_{SNOOZE}. I_{SNOOZE} is used to provide a light load indication (e.g., LIGHT_LOAD in FIG. 5) when other parts of the PWM/PFM mode control circuitry 220A are off.

In some example embodiments, I_{SNOOZE} is adjusted for different duty cycles. Table 1 shows I_{SNOOZE} for different V_{IN}, V_{OUT}, switching periods (T) and related frequencies.

TABLE 1

| | | | | |
|---|---|---|---|---|
| V_{IN} | V_{OUT} | I_{SNOOZE} | T | Frequency |

| | | | | | | | |
|---|---|---|---|---|---|---|---|
| 3.6 | V | 5 V | 96 | nA | 5 | μs | 200 kHz |
| 1.8 | V | 5 V | 213 | nA | 2.34 | μs | 427 kHz |
| 1 | V | 5 V | 265 | nA | 1.8 | μs | 530 kHz |

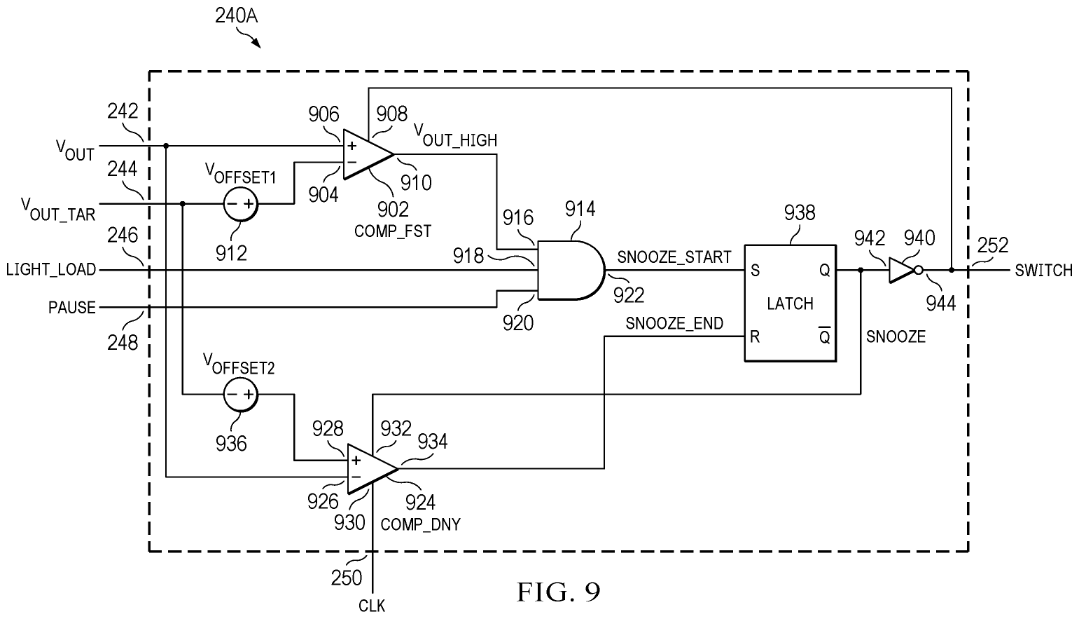

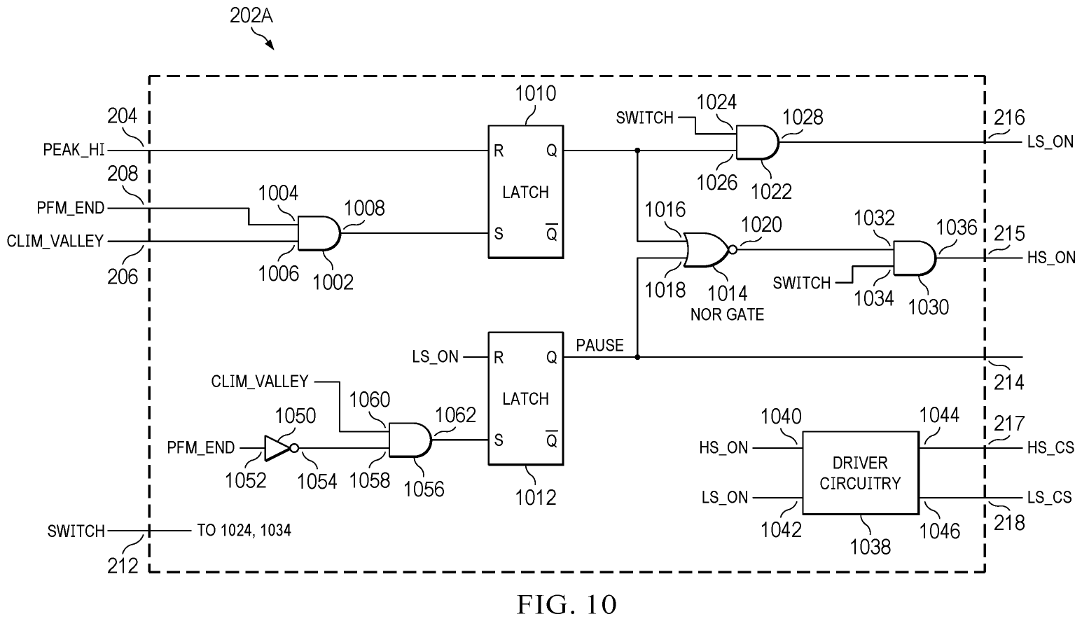

FIG. 9 is a schematic diagram showing inactive load mode control circuitry 240A (an example of the inactive load mode control circuitry 240 in FIG. 2) in accordance with an example embodiment. As shown, the inactive load mode control circuitry 240A includes the first control input 242, the second control input 244, the third control input 246, the fourth control input 248, the clock input 250, and the control output 252 described for the inactive load mode control circuitry 240 of FIG. 2.

In some example embodiments, the inactive load mode control circuitry 240A of FIG. 9 includes a first comparator (labeled “COMP_FST”) 902, a V_{OFFSET1} source 912, an AND gate 914, a second comparator (labeled “COMP_DNY) 924, a V_{OFFSET2} source 936, an SR latch 938 and an inverter 940 in the arrangement shown. As shown, the first comparator 902 has an inverting (“−”) input 904, a non-inverting (“+”) input 906, an enable input 908, and a comparator output 910. The second comparator 924 has an inverting (“−”) input 926, a non-inverting (“+”) input 928, a clock input 930, an enable input 932, and a comparator output 934. The AND gate 914 has a first gate input 916, a second gate input 918, a third gate input 920, and a gate output 922. The SR latch 938 has an S input, an R input, a Q output, and a Q output. The inverter 940 has an inverter input 942 and an inverter output 944.

In the example of FIG. 9, the non-inverting (“+”) input 908 of the first comparator 902 is coupled to the first control input 242 of the inactive load mode control circuitry 240A. The inverting (“−”) input 904 of the first comparator 902 is coupled to the second control input 244 of the inactive load mode control circuitry 240A via the V_{OFFSET1} source 912, which adds V_{OFFSET1} to V_{OUT_TAR}. The enable input 908 of the first comparator 902 is coupled to the inverter output 944. The comparator output 910 of the first comparator 902 is coupled to the first gate input 916 of the AND gate 914. The signal at the comparator output 910 is labeled V_{OUT}_HIGH and indicates when V_{OUT} is greater than V_{OUT_TAR}+V_{OFFSET1} (i.e., a snooze phase should start)

The inverting (“−”) input 926 of the second comparator 924 is coupled to the first control input 242 of the inactive load mode control circuitry 240A. The non-inverting (“+”) input 928 of the second comparator 924 is coupled to the second control input 244 of the inactive load mode control circuitry 240A via the V_{OFFSET2} source 936, which adds V_{OFFSET2} to V_{OUT_TAR}. The clock input 930 of the second comparator 924 is coupled to the clock input 250 of the inactive load mode control circuitry 240A to receive CLK. The enable input 932 of the second comparator 924 is coupled to the Q output of the SR latch 938. The comparator output 934 of the second comparator 924 is coupled to the R input of the SR latch 938. As shown, the signal at the comparator output 934 is labeled SNOOZE_END and indicates when V_{OUT} is less than V_{OUT_TAR}+V_{OFFSET2} (i.e., the snooze phase should end).

As shown, the second gate input 918 of the AND gate 914 is coupled to the third control input 246 of the inactive load mode control circuitry 240A to receive LIGHT_LOAD. The third gate input 920 of the AND gate 914 is coupled to the fourth control input 248 of the inactive load mode control circuitry 240A to receive PAUSE. The gate output 922 of the AND gate 914 is coupled to the S input of the SR latch 938. As shown, the signal at the gate output 922 is labeled SNOOZE_START and indicates that V_{OUT} is greater than V_{OUT_TAR}+V_{OFFSET1}. In the example of FIG. 9, when V_{OUT}_HIGH, PAUSE, and LIGHT_LOAD are high, SNOOZE_START is high. The Q output of the SR latch 938 is coupled to the inverter input 942, and the enable input 932 of the second comparator 924. The inverter output 944 is coupled to the control output 252 of the inactive load mode control circuitry 240A and the enable input 908 of the first comparator 902. As shown, the signal at the inverter output 944 is SWITCH. In some example embodiments, SWITCH is used as an enable signal for some components of the PWM/PFM mode control circuitry 220A (e.g., the first comparator 502, the second comparator 504, and/or the error amplifier 518 of the PWM/PFM mode control circuitry 220A in FIG. 5) and/or to gate some signals (e.g., LS_ON and HS_ON) of the boost control circuitry 202.

In operation, the inactive load mode control circuitry 240A is configured to: receive V_{OUT} at the first control input 242; receive V_{OUT_TAR} at the second control input 244; receive LIGHT_LOAD at the third control input 246; receive PAUSE at the fourth control input 248; receive CLK at the clock input 250; and provide SWITCH at the control output 252 responsive to V_{OUT}, V_{OUT}_TAR, V_{OFFSET1}, V_{OFFSET2}, LIGHT_LOAD and PAUSE. In some example embodiments, the inactive load mode control circuitry 240A reduces power consumption by only enabling one of the first comparator 902 and the second comparator 924 at a time. When SNOOZE is high, the second comparator 924 is enabled to determine when to end a snooze phase. When SWITCH is high, the first comparator 902 is enabled to determine when to start a snooze phase. In some example embodiments, the inactive load mode control circuitry 240A is configured to use negative hysteresis control (e.g., using the first and second comparators 902 and 924) with V_{OFFSET2} greater than V_{OFFSET1} to reduce V_{OUT} ripple during inactive load mode operations.

In some example embodiments, when I_{EA} is low clamped, V_{OUT} will ramp up until the inactive load mode is entered. In a conventional positive hysteresis control approach, V_{OFFSET1} is greater than V_{OFFSET2}. Thus, in a conventional inactive load mode, when V_{OUT}>V_{OUT_TAR}+V_{OFFSET1}, the switching phase stops and the snooze phase begins causing V_{OUT} to drop. When V_{OUT}<V_{OUT_TAR}+V_{OFFSET2}, the snooze phase stops and the switching phase begins causing V_{OUT} to rise.

In contrast, with the inactive load mode control circuitry 240A of FIG. 10, V_{OFFSET2} is greater than V_{OFFSET1}. The inactive load mode control circuitry 240A increases V_{OUT} as needed using single-pulse based on negative hysteresis voltage control, where V_{OFFSET2} is greater than V_{OFFSET1}.

FIG. 10 is a schematic diagram showing boost control circuitry 202A (an example of the boost control circuitry 202 of FIG. 2) in accordance with an example embodiment. As shown, the boost control circuitry 202A has the first control input 204, the second control input 206, the third control input 208, the fourth control input 212, the first control output 214, the second control output 215, the third control output 216, the fourth control output 217, and the fifth control output 218 described for the boost control circuitry 202 of FIG. 2.

In some example embodiments, the boost control circuitry 202A includes a first AND gate 1002, a first SR latch 1010, a second SR latch 1012, a NOR gate 1014, a second AND gate 1022, a third AND gate 1030, a fourth AND gate 1056, an inverter 1050, and driver circuitry 1038 in the arrangement shown. The first AND gate 1002 has a first gate input 1004, a second gate input 1006, and a gate output 1008. The first SR latch 1010 has an R input, an S input, a Q output, and a Q̅ output. The second SR latch 1012 has an R input, an S input, a Q output, and a Q̅ output. The NOR gate 1014 has a first gate input 1016, a second gate input 1018, and a gate output 1020. The second AND gate 1022 has a first gate input 1024, a second gate input 1026, and a gate output 1028. The third AND gate 1030 has a first gate input 1032, a second gate input 1034, and a gate output 1036. The fourth AND gate 1056 has a first gate input 1058, a second gate input 1060, and a gate output 1062. The inverter 1050 has an inverter input 1052 and an inverter output 1054. The driver circuitry 1038 has a first driver input 1040, a second driver input 1042, a first driver output 1044, and a second driver output 1046.

As shown, the first gate input 1004 of the first AND gate 1002 is coupled to the third control input 208 to receive PFM_END. The second gate input 1006 of the first AND gate 1002 is coupled to the second control input 206 to receive CLIM_VALLEY. The gate output 1008 of the first AND gate 1002 is coupled to the S input of the first SR latch 1010. The R input of the first SR latch 1010 is coupled to the first control input 204 to receive PEAK_HI. The Q output of the first SR latch 1010 is coupled to the second gate input 1026 of the second AND gate 1022 and to the first gate input 1016 of the NOR gate 1014. The second gate input 1026 of the second AND gate 1022 is coupled to the fourth control input 212 to receive SWITCH. The gate output 1028 of the second AND gate 1022 is coupled to the third control output 216 to provide LS_ON.

As shown, the second gate input 1018 of the NOR gate 1014 is coupled to the Q output of the second SR latch 1012. The Q output of the second SR latch 1012 is coupled to the first control output 214. In the example of FIG. 10, the signal at the Q output of the second SR latch 1012 is PAUSE. The gate output 1020 of the NOR gate 1014 is coupled to the first gate input 1032 of the third AND gate 1030. The second gate input 1034 of the third AND gate 1030 is coupled to the fourth control input 212 to receive SWITCH. The gate output 1036 of the third AND gate 1030 is coupled to the second control output 215 to provide HS_ON.

The R input of the second SR latch 1012 is coupled to the gate output 1028 of the second AND gate 1022 to receive LS_ON. The S input of the second SR latch 1012 is coupled to the gate output 1062 of the fourth AND gate 1056. The first gate input 1058 of the fourth AND gate 1056 is coupled to the inverter output 1054 of the inverter 1050. The inverter input 1052 of the inverter 1050 is coupled to the third control input 208 to receive PFM_END. The second gate input 1060 of the fourth AND gate 1056 is coupled to the second control input 206 to receive CLIM_VALLEY.

The first driver input 1040 of the driver circuitry 1038 is coupled to the gate output 1036 of the third AND gate 1030 to receive HS_ON. The second driver input 1042 of the driver circuitry 1038 is coupled to the gate output 1028 of the second AND gate 1022 to receive LS_ON. The first driver output 1044 of the driver circuitry 1038 is coupled to the fourth control output 217 and provides HS_CS responsive to HS_ON. The second driver output 1046 of the driver circuitry 1038 is coupled to the fifth control output 218 and provides LS_CS responsive to LS_ON.

In operation, the inactive load mode control circuitry 240A is configured to: receive PEAK_HI at the first control input 204; receive CLIM_VALLEY at the second control input 206; receive PFM_END at the third control input 208; receive SWITCH at the fourth control input 212; provide PAUSE at the first control output 214 responsive to CLIM_VALLEY, PFM_END, and LS_ON; provide HS_ON at the second control output 215 responsive to PEAK_HI, PFM_END, CLIM_VALLEY, and SWITCH; provide LS_ON at the third control output 216 responsive to PEAK_HI, PFM_END, CLIM_VALLEY, and SWITCH; provide HS_CS at the fourth control output 217 responsive to HS_ON; and provide LS_CS at the fifth control output 218 responsive to LS_ON.

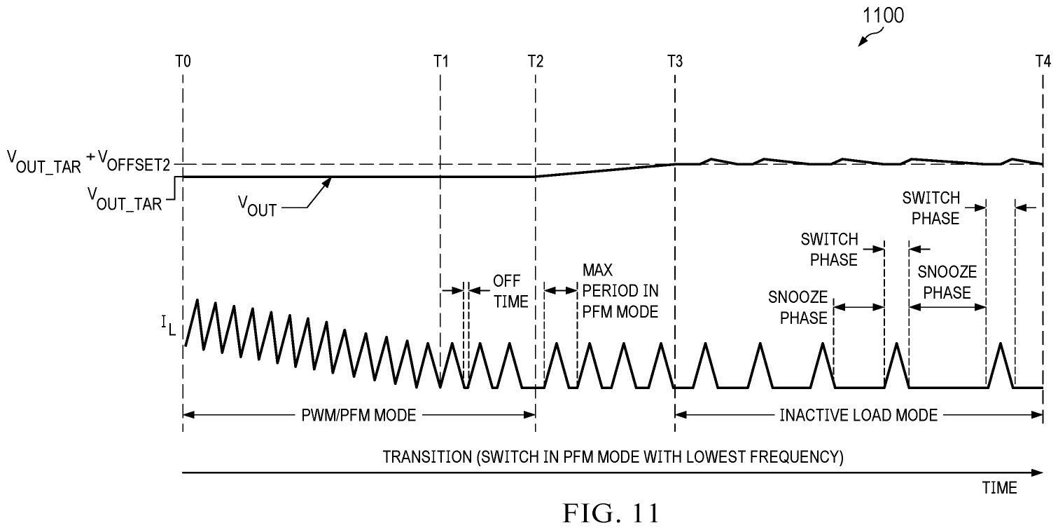

FIG. 11 is a timing diagram 1100 showing signals related to different operational modes of a boost converter controller (e.g., the controller 140 in FIG. 1, or the controller 140A in FIG. 2) in accordance with an example embodiment. In the timing diagram, a PWM mode is used from time T0 to T1. During the PWM mode, the HS switch 126 and the LS switch 130 are on alternately for each switching cycle based on the respective control signals HS_CS and LS_CS. In some example embodiments, HS_CS is generated responsive to HS_ON, while LS_CS is generated responsive to LS_ON. Further, HS_ON and LS_ON generated responsive to CLIM_VALLEY and PEAK_HI. For example, when CLIM_VALLEY is asserted, LS_ON may be asserted and HS_ON may be de-asserted. When PEAK_HI is asserted, LS_ON is de-asserted and HS_ON is asserted. At time T1, when load current (the average I_{L}) decreases sufficiently, a PFM mode is used, in which there is an off time in each switching cycle. During the off time, both the HS switch 126 and the LS switch 130 are off. With the PFM mode, V_{OUT} is regulated to V_{OUT_TAR}. From time T1 to T2, the load current continues to decrease, the off time used for the PFM mode increases, and V_{OUT} is regulated to V_{OUT_TAR}. Starting at time T2, I_{EA} and I_{EA_PFM} are low clamped, and the period of PFM mode reaches a maximum value based on the low clamped I_{EA_PFM}. With the PFM period set to a maximum, further decreases in load current result in V_{OUT} increasing.

Starting from time T3, in response to V_{OUT} reaching V_{OUT_TAR}+V_{OFFSET2}, the inactive load mode is used, in which V_{OUT} is regulated to V_{OUT_TAR}+V_{OFFSET2}. In the inactive load mode, the first comparator 502 (PEAK COMP) and the second comparator 504 (VALLEY COMP) of the PWM/PFM mode control circuitry 220A are disabled. During each period of the inactive load mode, there is a switch phase and a snooze phase. In some example embodiments, only two threshold voltage levels V_{OUT_TAR} and V_{OUT_TAR}+V_{OFFSET2} are used to support three different operational modes (e.g., the PWM mode, the PFM mode, and the inactive load mode).

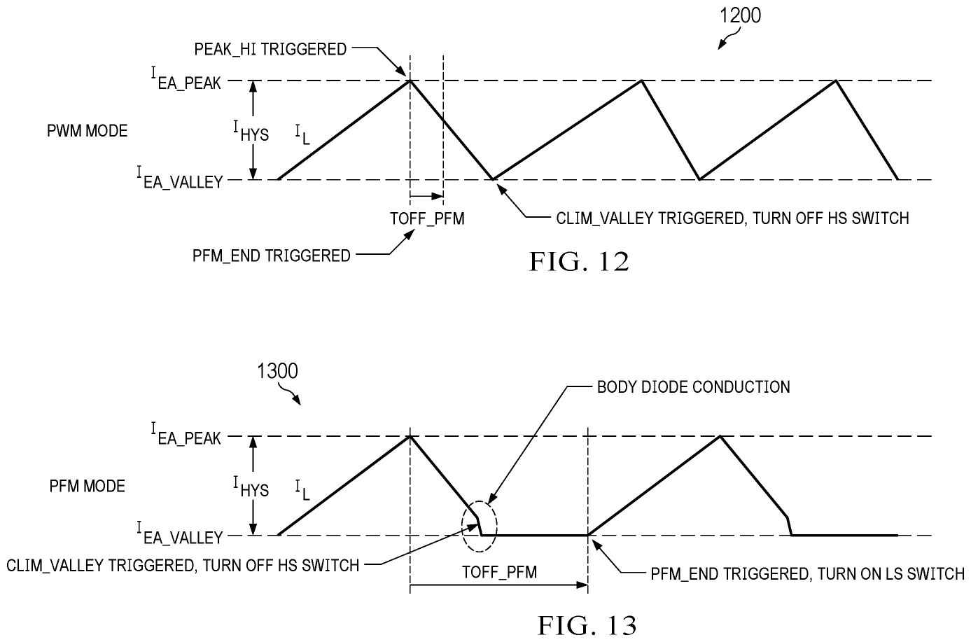

FIG. 12 is a timing diagram 1200 showing I_{L} during a PWM mode of a controller in accordance with an example embodiment. In the timing diagram 1200, I_{L} ramps up and down between I_{EA_VALLEY} and I_{EA_PEAK}, where the difference between I_{EA_VALLEY} and I_{EA_PEAK} is I_{HYS}. Also, TOFF_PFM is a period between the LS switch 130 turning off and PFM_END being asserted. When the I_{EA} is high, then TOFF_PFM is small, and CLIM_VALLEY is triggered later than the PFM_END signal. In such case, the LS switch 130 will turn on and PAUSE (the amount of off time in each switching cycle) will be zero as shown in FIG. 12. As needed, PEAK_HI is triggered to turn off the LS switch 130, and CLIM_VALLEY is triggered to turn off the HS switch 126.

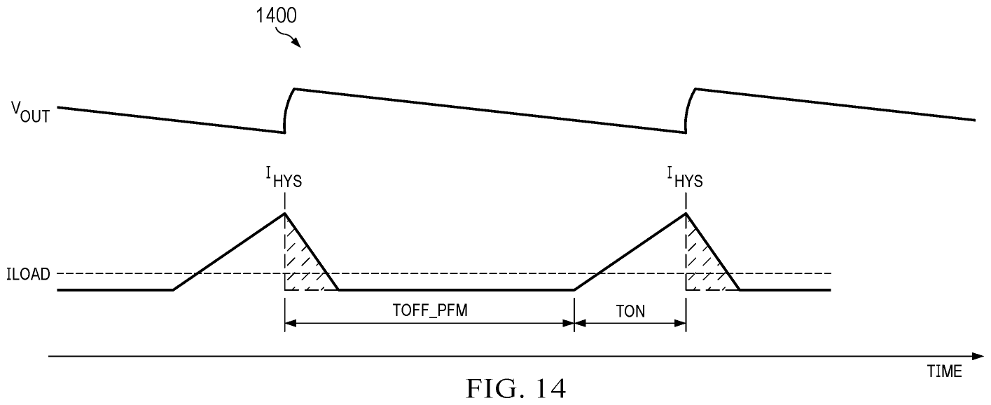

FIG. 13 is a timing diagram 1300 showing I_{L} during a PFM mode of a controller in accordance with an example embodiment. In the timing diagram 1300, I_{L} ramps up and down between I_{EA_VALLEY} and I_{EA_PEAK}, where the difference between I_{EA_VALLEY} and I_{EA_PEAK} is I_{HYS}. In some example embodiments, I_{EA_VALLEY} and I_{EA_PFM} are used to control the valley current and the PFM timer circuit 508. When I_{EA} is low, TOFF_PFM is greater than the off time of the LS switch 130 in PWM mode. In such case, the PFM timer circuit 508 will dominate the control scheme and turn the LS switch 130 on.

FIG. 14 is a timing diagram 1400 showing I_{L} and a V_{OUT} during a mode transition of a controller in accordance with an example embodiment. For the timing diagram 1400, the load current is maintained to be constant during the transition from PFM mode to the inactive load mode. In some example embodiments, M13 has a threshold voltage Vth close to 0V. In such case, C_{PFM}=0.5 pF, V_{PFM}=1 V, I_{LOAD}=8 mA, I_{HYS}=0.35A, L=1 uH. Also, I_{SNOOZE}=65 nA*(V_{OUT}-V_{IN})+I_{MIN}, where I_{MIN} is used for when V_{OUT} is close to V_{IN}. If V_{OUT}=5V and V_{IN}=3.6 or 1.8V or 1V, the respective low clamped frequency is calculated as 200 KHz, 427 KHz, or 530 KHz as shown in Table 1. For the I_{SNOOZE} source 516A in FIG. 8, assume: R1=R4=4MΩ; R2=R5=2MΩ; and R3=R6=3.8MΩ. In such case, I_{SNOOZE}=(V_{OUT}−V_{IN})*R2/(R1+R2)/R3+5 nA=65 nA (V_{OUT}−V_{IN})+5 nA. In PFM mode, I_{EA} controls the PFM timer circuit 508. When I_{EA} is low clamped, TOFF_PFM reaches its maximum value, the PFM frequency is at its lowest, and V_{OUT} will rise. In the example of FIG. 14, the shaded area is the energy delivered to the output. Assuming:

I_{LOAD}=Q/T=Q/(TOFF_PFM+TON)=Q/TOFF_PFM, Equation (1)

where Q=0.5*I_{HYS}*I_{HYS}*L/(V_{OUT}−V_{IN}) (the area of the shaded region). In such case,

TOFF_PFM=Q/lOAD=0.5*I_{HYS}*I_{HYS}*L/(V_{OUT}−V_{IN})/I_{LOAD}. Equation (2)

From the PFM timer circuit 508, TOFF_PFM may be calculated as:

TOFF_PFM=C_{PFM}*V_{PFM}/I_{EA_PFM}. Equation (3)

When in transition, I_{EA_PFM}=I_{SNOOZE} as shown in FIG. 5. From equations 1 and 2, I_{SNOOZE}=2*C_{PFM}*V_{PFM}*I_{LOAD}*(V_{OUT}−V_{IN})/(I_{HYS}*I_{HYS}*L). In other words, I_{SNOOZE}=(V_{OUT}−V_{IN})/R, where R=0.5*I_{HYS}*I_{HYS}*L/(I_{LOAD}*C_{PFM}*V_{PFM}).

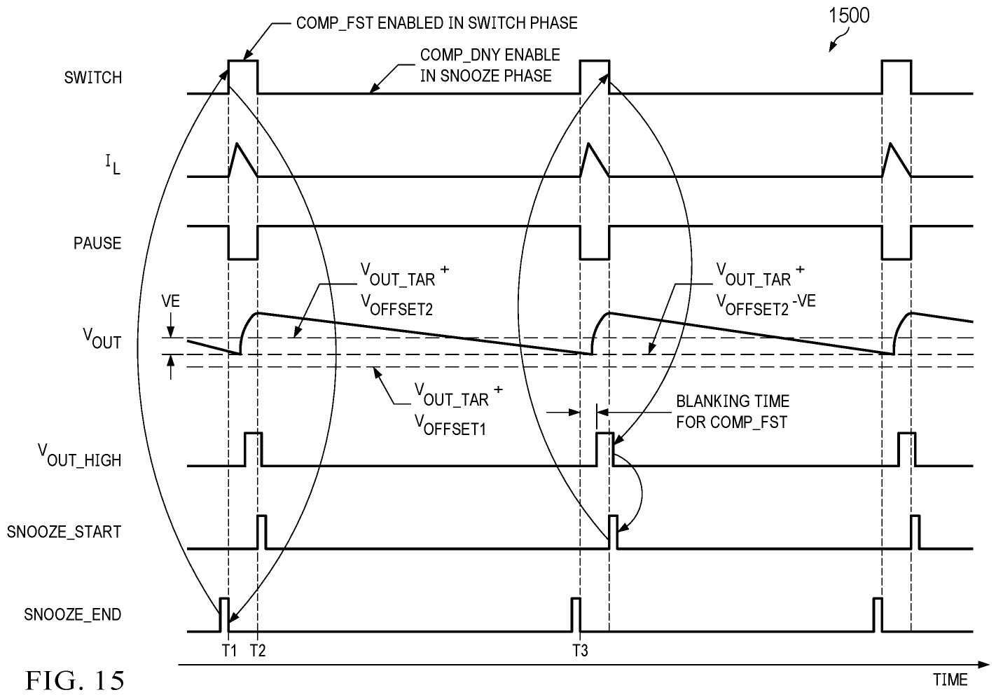

FIG. 15 is a timing diagram 1500 showing signals related to an inactive load mode of a controller in accordance with an example embodiment. In the timing diagram 1500, V_{OUT} is regulated to V_{OUT_TAR} V_{OFFSET2}. In the snooze phase V_{OUT} drops and at time T1, V_{OUT} drops below V_{OUT_TAR} V_{OFFSET2}. In response, the output of the second comparator 924 is high, SNOOZE is de-asserted, the snooze phase ends, and the switch phase begins. In some example embodiments, the threshold used to switch from the snooze phase to the switch phase accounts for comparator error (VE) (e.g., when V_{OUT}=V_{OUT_TAR}+V_{OFFSET2}−VE, the snooze phase ends and the switch phase begins). From time T1 to T2, the switch phase is used, the first comparator 902 is enabled, PAUSE=0, V_{OUT} rises, and SNOOZE=0. In some example embodiments, the overdrive voltage of the first comparator 902 is Voverdrive=V_{OFFSET2}−V_{OFFSET1}−VE, which may be about 10-25 mV. In such case, the first comparator 902 can respond in one switching cycle (e.g., 300n5). When V_{OUT}>V_{OUT_TAR}+V_{OFFSET1}, SNOOZE=1, PAUSE=1, and after one switching cycle (at time T2), the converter will go to snooze phase. As shown in FIG. 15, there is a relatively long snooze phase interval between times T2 and T3. To force a single pulse operation, V_{OFFSET2}−V_{OFFSET1} should be slightly greater than VE.

In some example embodiments, a boost converter controller (e.g., the controller 140 in FIG. 1, or the controller 140A in FIG. 2) reduces V_{OUT} ripple and improves transition efficiency based on: use of only two voltage levels for control of the PWM mode, the PFM mode, and the inactive load mode; a constant load threshold for PFM mode to inactive load mode transitions; V_{OUT} ripple control using two comparators in the inactive load mode; and single pulse operation in the inactive load mode using a negative hysteresis voltage control technique.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A boost converter control method comprising:
receiving an output voltage;
receiving an output voltage target;
triggering a snooze phase start of an inactive load mode based on a comparison of the output voltage relative to the output voltage target plus a first output voltage target offset; and
triggering a snooze phase end of the inactive load mode based on a comparison of the output voltage relative to the output voltage target plus a second output voltage target offset, the second output voltage target offset greater than the first output voltage target offset.

2. The boost converter control method of claim 1, further comprising using only two thresholds for regulation of the output voltage during a pulse-wide modulation (PWM) mode, a pulse-frequency modulation (PFM) mode, and the inactive load mode.

3. The boost converter control method of claim 2, further comprising using a constant load threshold for PFM mode to inactive load mode transitions.

4. The boost converter control method of 3, wherein the constant load threshold is determined using a low-clamped error amplifier current (I_{EA}) responsive to an input voltage and the output voltage.

5. The boost converter control method of claim 4, further comprising determining a maximum period of the PFM mode responsive to the low-clamped I_{EA}.

6. The boost converter control method of claim 1, further comprising performing a single pulse operation during a switch phase of the inactive load mode.

7. The boost converter control method of claim 1, further comprising using negative hysteresis voltage control to trigger the snooze phase start and the snooze phase end in the inactive load mode.

8. The boost converter control method of claim 2, further comprising using an error amplifier current to control an inductor valley current and a PFM timer circuit.

9. A controller, comprising:
boost control circuitry having a first control input, a second control input, a third control input, a fourth control input, a first control output, a second control output, a third control output, a fourth control output, and a fifth control output;
PWM/PFM mode control circuitry having a fifth control input, a sixth control input, a seventh control input, an eighth control input, a ninth control input, a tenth control input, an eleventh control input, a sixth control output, a seventh control output, an eighth control output, a ninth control output and a ground terminal, the tenth control input coupled to the second control output, the eleventh control input coupled to the third control output, the seventh control output coupled to the first control input, eighth control output coupled to the second control input, the ninth control output coupled to the third control input; and
inactive load mode control circuitry having an eleventh control input, a twelfth control input, a thirteenth control input, a fourteenth control input, a clock input, and a tenth control output, the fourteenth control input coupled to first control output, the tenth control output coupled to the fourth control input, the inactive load mode control circuitry configured to:
use a first output voltage target offset to trigger a snooze phase start of an inactive load mode; and
use a second output voltage target offset to trigger a snooze phase end of the inactive load mode, the second output voltage target offset greater than the first output voltage target offset.

10. The controller of claim 9, wherein inactive load mode control circuitry includes:
a first comparator having a first non-inverting input, a first inverting input and a first comparator output, the first non-inverting input is coupled to the eleventh control input, and the first inverting input is coupled to the twelfth control input and a first output voltage target offset source; and
a second comparator having a second non-inverting input, a second inverting input and a second comparator output, the second non-inverting input is coupled to the twelfth control input and a second output voltage target offset source, and the second inverting input is coupled to the eleventh control input,
wherein the inactive load mode control circuitry is configured to receive the output voltage at the eleventh control input and an output voltage target at the twelfth control input.

11. The controller of claim 9, wherein the controller is configured to use only two thresholds for regulation of the output voltage during a pulse-wide modulation (PWM) mode, a pulse-frequency modulation (PFM) mode, and an inactive load mode.

12. The controller of claim 11, wherein the controller is configured to use a constant load threshold for PFM mode to inactive load mode transitions.

13. The controller of claim 9, wherein the controller is configured to perform a single pulse operation during a switch phase of the inactive load mode.

14. The controller of claim 9, wherein the controller is configured to use negative hysteresis voltage control to trigger the snooze phase start and the snooze phase end in the inactive load mode.

15. The controller of claim 9, wherein the PWM/PFM mode control circuitry includes a low clamp circuit configured to provide a light load indication responsive to an input voltage, the output voltage, and an output voltage target.

16. A system comprising:
a power stage having a first power input, a first ground terminal, first and second control inputs, a sense output, and a power output; and
a controller having a first, second and third sense inputs, a second ground terminal, and first and second control outputs, the first sense input coupled to the power output, the second sense input coupled to the sense output, the third sense input coupled to the first power input, the first control output coupled to the first control input, the second control output coupled to the second control input, the controller including boost control circuitry, pulse-wide modulation/pulse-frequency modulation (PWM/PFM) mode control circuitry and inactive load mode control circuitry,
the inactive load mode control circuitry is configured to:
use a first output voltage target offset to trigger a snooze phase start of an inactive load mode; and
use a second output voltage target offset to trigger a snooze phase end of the inactive load mode, the second output voltage target offset greater than the first output voltage target offset.

17. The system of claim 16, wherein inactive load mode control circuitry includes a first comparator and a second comparator, the first comparator configured to determine when the output voltage exceeds an output voltage target plus the first output voltage target offset, and the second comparator configured to determine when the output voltage exceeds the output voltage target plus the second output voltage target offset.

18. The system of claim 17, wherein the first comparator has a first non-inverting input, a first inverting input and a first comparator output, the second comparator has a second non-inverting input, a second inverting input and a second comparator output,
the first comparator configured to:
receive the output voltage at the first non-inverting input;
receive the output voltage target at the first inverting input;
receive the first output voltage target offset at the first inverting input; and
provide an output voltage high signal at the first comparator output responsive to the output voltage, the output voltage target, and the first output voltage target offset; and
the second comparator configured to:
receive the output voltage at the second inverting input;
receive the output voltage target at the second non-inverting input;
receive the second output voltage target offset at the second non-inverting input; and
provide a snooze phase end signal at the comparator output responsive to the output voltage, the output voltage target, and the second output voltage target offset.

19. The system of claim 16, wherein the controller is configured to use only two thresholds for regulation of the output voltage during a pulse-wide modulation (PWM) mode, a pulse-frequency modulation (PFM) mode, and an inactive load mode.

20. The system of claim 19, wherein the controller is configured to use a constant load threshold for PFM mode to inactive load mode transitions.

21. The system of claim 16, wherein the controller is configured to perform a single pulse operation during a switch phase of the inactive load mode.

22. The system of claim 16, wherein the controller is configured to use negative hysteresis voltage control to trigger the snooze phase start and the snooze phase end in the inactive load mode.
